(19) United States
(12) Patent Application Publication
(10) Pub. No.: US 2013/0339053 A1
(43) Pub. Date: Dec. 19, 2013

(54) REGIONAL ANALYSIS OF ELECTRONIC HEALTH RECORD DATA USING GEOGRAPHIC INFORMATION SYSTEMS AND STATISTICAL DATA MINING

(71) Applicant: Children's National Medical Center, (US)

(72) Inventors: Brian R. JACOBS, Annapolis, MD (US); Katelyn Tambellini, Bethesda, MD (US); Jefferson E. McMillan, Bristow, VA (US)

(73) Assignee: Children's National Medical Center, Washington, DC (US)

(21) Appl. No.: 13/860,799

(22) Filed: Apr. 11, 2013

Related U.S. Application Data
(60) Provisional application No. 61/622,708, filed on Apr. 11, 2012.

(51) Int. Cl. G06F 19/00

(52) U.S. Cl. CPC G06F 19/3443
USPC 705/3

(57) ABSTRACT

Population-level health outcomes are observed by using millions of granular, de-identified health elements in electronic patient records. A GIS is integrated with EHR-derived data and uses data mining tools to spatially analyze EHR data, including proper selection of appropriate EHR data fields, retrieving EHR data (using three ubiquitous reporting languages), cleaning, and de-identifying the data. The cleaned EHR data are mapped against multiple geographic/environmental data layers in the GIS, and statistical spatial analyses of the EHR data are performed in a SQL database using data mining tools.

### REFERENCE TO RELATED APPLICATION

The present application claims the benefit of U.S. Provisional Patent Application No. 61/622,708, filed Apr. 11, 2012, whose disclosure is hereby incorporated by reference in its entirety into the present disclosure.

### FIELD OF THE INVENTION

The present invention is directed to regional or national analysis of health data and more particularly to a methodology for regional or national analysis of electronic health record data using Geographic Information Systems (GIS) and statistical data mining.

### DESCRIPTION OF RELATED ART

Geospatial information is a common way of analyzing environmental impact on populations, and has been used in health related research since the days of Dr. John Snow in 1854. Using an innovative methodology to examine geographic variation of cholera cases in lower England, Dr. Snow was able to pinpoint the location of a cholera outbreak to a river tap used by a certain water provider.¹ Subsequently, health researchers have used geospatial methodologies and GIS to evaluate chronic healthcare conditions²⁻⁹ as well as acute disease outbreaks.^{10,11}

All geospatial analysis begins with the gathering of essential information variables related to the study topic. Geospatial analysis in healthcare may include patient specific demographic and healthcare data, environmental data, geographic data and other data as appropriate. For example, when studying the condition asthma, the relevant data may include regional pollution information, pollen counts, weather, smoking information, public health data on viral activity, socioeconomic variables, nutritional information, patient age, gender, race, ethnicity, etc. This information must then be given a geographic aspect such as the presence of the information by state, county, zipcode, census tract, voting district, neighborhood council, etc. While many geocoding and aggregation techniques exist for handling healthcare data, most have relied upon aggregating patient data to high level, low resolution geographic distribution in order to protect patient privacy. Under HIPAA, patient specific identifiable information must be removed from analytical datasets in order to protect the privacy of the patient.¹² Since the patient's address is included as an identifier under HIPAA, most studies aggregate patient data to a level where patients cannot be individually identified. Studies have chosen to either aggregate patient geospatial date to the U.S. Census Block Group¹³⁻¹⁶, U.S. Census Track, or Zip Code^{9,17-19} levels. Unfortunately, aggregation to any of these levels prevents a high resolution analysis, which can lessen the credibility of the study results. This method also limits the ability to assign accurate co-variable values, such as household income, ethnicity, race, or specific healthcare variables (i.e. medications, lab results, care orders, radiology results, pathology reports, vital sign measurements and others).²⁰ The lack of resolution has been listed as a limitation in several studies using a geospatial approach.

EHR systems are a relatively new technology in the healthcare industry²¹, in which there has been a rapid adoption over the last several years by both independent physicians and hospital systems. Recently, investment in an EHR infrastructure has become a federal priority.^{22,23} While EHR technology is critical in the improvement of healthcare delivery quality, it also provides numerous advantages for healthcare research.²⁴ One of the primary improvements that EHRs provide is an increase in amount and availability of adequate subjects to make up a research sample.^{22,23} Inadequate patient sample size has long plagued healthcare condition specific, public and population health research. In recent years, studies using EHR technology have increased their sample size to a sufficient level to draw adequate conclusions.^{16,25,26} Unfortunately, that increase in sample availability has not been coordinated with a granular and detailed model for geospatial assessment.

EHR technology also allows researchers to gather data collected in the course of normal care delivery. This data collection technique improves the accuracy and relevance of data collected and the confidence in the conclusions drawn. Natural collection techniques eliminate a great deal of bias from traditional sampling methodology.^{1,27} EHRs also contribute to the feasibility of large, multi-region research studies by reducing the time for data collection.¹⁷ Queries created in the EHR can generate several thousand records in seconds. Leveraging EHR technology in population health studies is a new discipline with strong integrative opportunities with geospatial technology.

Exploration of EHR data integration with geospatial technology has been stunted due to the novelty of the EHR and its delayed implementation in the healthcare environment. There has been only one publication describing the use EHR data combined with geospatial technology—an early and non-comprehensive investigation.²⁸ Thus, the healthcare industry lacks a systematic, integrated model for data acquisition, aggregation, validation, de-identification, and integration of EHR data with GIS. The industry also lacks an ability to display the results of such analyses in a useful manner, making any advances in marrying the two technologies suboptimal. Both the underlying methodology, as well as the presentation of any results, is necessary to understand population level relationships between patient health and residence location.

U.S. Pat. No. 8,108,381 describes a system and methodology for analyzing electronic data records, specifically those found in Electronic Health Records. While this patent describes a method for creating relationships based on the EHR data, it does not address privacy issues related to the derivation of health data from an EHR system. The patented methodology only addresses creating “concept vectors” and comparing their relationships, not addressing the impact of patient location on those relationships.

U.S. Pat. No. 8,250,013 presents a system and methodology for protecting patient privacy while modeling lung cancer survival analysis. While this methodology is specific to cancer survival analysis, it does address the privacy aspect of the presented methodology. This patent asserts using a matrix approach to protecting the identity of patients from different institutions. This methodology, however, does not address how to protect patient information when using geo-locations for those patients.

U.S. Pat. No. 8,296,299 asserts a methodology for de-identification of health data using geography. This method uses a continuously smaller geographic sub-division and an algorithm for calculating the minimum patient number in each sub-division. The patient privacy comes when a sub-division no longer meets the algorithm, and thus the sub-division above will be the smallest sub-division for analysis. This method does not address how approaching a specific health problem could be done with a low resolution solution as presented. The methodology limits the analysis of the data to a low resolution situation, and is not useful for analyzing regional or national population health.

Other references include:

Gordis L. Epidemiology. 4th ed. Philadelphia: Saunders Elsevier; 2009.

Yamashita T, Kunkel S R. The association between heart disease mortality and geographic access to hospitals: county level comparisons in Ohio, USA. Social science & medicine (1982). April 2010; 70(8):1211-1218.

Wen M, Kowaleski-Jones L. The built environment and risk of obesity in the United States: racial-ethnic disparities. Health & place. November 2012; 18(6):1314-1322.

Gale S L, Magzamen S L, Radice J D, Tager I B. Crime, neighborhood deprivation, and asthma: a GIS approach to define and assess neighborhoods. Spatial and spatio-temporal epidemiology. June 2011; 2(2):59-67.

Sage W M, Balthazar M, Kelder S, Millea S, Pont S, Rao M. Mapping data shape community responses to childhood obesity. Health affairs (Project Hope). March-April 2010; 29(3):498-502.

Hoang C, Kolenic G, Kline-Rogers E, Eagle K A, Erickson S R. Mapping geographic areas of high and low drug adherence in patients prescribed continuing treatment for acute coronary syndrome after discharge. Pharmacotherapy. October 2011; 31(10):927-933.

Pedigo A, Aldrich T, Odoi A. Neighborhood disparities in stroke and myocardial infarction mortality: a GIS and spatial scan statistics approach. BMC public health. 2011; 11:644.

Saelens B E, Sallis J F, Frank L D, et al. Obesogenic neighborhood environments, child and parent obesity: the Neighborhood Impact on Kids study. American journal of preventive medicine. May 2012; 42(5):e57-64.

Rundle A, Neckerman K M, Sheehan D, et al. A prospective study of socioeconomic status, prostate cancer screening and incidence among men at high risk for prostate cancer. Cancer causes & control: CCC. February 2013; 24(2):297-303.

Yang K, LeJeune J, Alsdorf D, Lu B, Shum C K, Liang S. Global distribution of outbreaks of water-associated infectious diseases. PLoS neglected tropical diseases. 2012; 6(2):e1483.

Vander Kelen P T, Downs J A, Stark L M, Loraamm R W, Anderson J H, Unnasch T R. Spatial epidemiology of eastern equine encephalitis in Florida. International journal of health geographics. 2012; 11:47.

Health Insurance Portability and Accountability Act, 110 Stat 1936 (1996).

Ryan L M, Guagliardo M, Teach S J, et al. The Association Between Fracture Rates and Neighborhood Characteristics in Washington, D.C., Children. Journal of investigative medicine: the official publication of the American Federation for Clinical Research. March 2013; 61(3):558-563.

Widener M J, Metcalf S S, Bar-Yam Y. Dynamic urban food environments a temporal analysis of access to healthy foods. American journal of preventive medicine. October 2011; 41(4):439-441.

Williams K G, Schootman M, Quayle K S, Struthers J, Jaffe D M. Geographic variation of pediatric burn injuries in a metropolitan area. Academic emergency medicine: official journal of the Society for Academic Emergency Medicine. July 2003; 10(7):743-752.

Guilbert T W, Arndt B, Temte J, et al. The theory and application of UW ehealth-PHINEX, a clinical electronic health record-public health information exchange. WMJ: official publication of the State Medical Society of Wisconsin. June 2012; 111(3):124-133.

DeStefano F, Eaker E D, Broste S K, et al. Epidemiologic research in an integrated regional medical care system: the Marshfield Epidemiologic Study Area. Journal of clinical epidemiology. June 1996; 49(6):643-652.

Modarai F, Mack K, Hicks P, et al. Relationship of opioid prescription sales and overdoses, North Carolina. Drug and alcohol dependence. Feb. 8, 2013.

Colvin J D, Zaniletti I, Fieldston E S, et al. Socioeconomic status and in-hospital pediatric mortality. Pediatrics. January 2013; 131(1):e182-190.

Marengo L, Ramadhani T, Farag N H, Canfield M A. Should aggregate US Census data be used as a proxy for individual household income in a birth defects registry? Journal of registry management. Spring 2011; 38(1):9-14.

Electronic Health Records Overview. McClean, V A: National Institutes of Health-National Center for Research Resources; April 2006.

Jha A K, DesRoches C M, Campbell E G, et al. Use of electronic health records in U.S. hospitals. The New England journal of medicine. Apr. 16, 2009; 360(16):1628-1638.

Jha A K, DesRoches C M, Kralovec P D, Joshi M S. A progress report on electronic health records in U.S. hospitals. Health affairs (Project Hope). October 2010; 29(10):1951-1957.

Pearson J F, Brownstein C A, Brownstein J S. Potential for electronic health records and online social networking to redefine medical research. Clinical chemistry. February 2011; 57(2):196-204.

Gold R, Angier H, Mangione-Smith R, et al. Feasibility of evaluating the CHIPRA care quality measures in electronic health record data. Pediatrics. July 2012; 130(1):139-149.

Quinn C T. A question of quality in sickle cell disease. Pediatric blood & cancer. April 2009; 52(4):435-436.

Altman D G. Practical Statistics for Medical Research. London: Chapman &Hall; 1991.

Zimeras S, Diomidous M, Zikos D, Theodossiou M. Integrating a geographic information system (GIS) with electronic health record: application for spatial epidemiological data. Acta Informatica Medica. 2009; 17(4):180-182.

### SUMMARY OF THE INVENTION

Since few explorations into uploading and analyzing EHR data within a GIS have been described, the health industry currently lacks an all-encompassing EHR data acquisition, cleaning, de-identification and data utilization methodology for spatial and statistical analysis.

It is therefore an object of the invention to provide such a methodology.

It is another object of the invention to provide such a methodology that can accurately and securely map patient health record data, while maintaining privacy, security and data integrity.

It is another object of the invention to provide such a methodology that uses data mining and analytical techniques to further understand population level relationships between patient demographics, health data elements, patient residences' geo-coordinates (offset for privacy) and other environmental and geographic co-variables.

It is another object of the invention to provide a methodology to gather data directly from the EHR and geocode the locations of each of the patient's residence, school, or social gathering points.

It is another object of the invention to provide real-time geocoding of patients in an EHR and presentation to EHR users of the location in relationship to other relevant health data.

These and other objects are accomplished by a methodology that combines all aspects of mining, validating, de-identifying, geocoding, and analyzing EHR-derived data. This method also involves geocoding of patient data to +/−0.0001 degrees latitude and/or longitude. This level is more precise than that of the lowest U.S. census sub-division, but still encompasses enough geographic area that the patient's privacy is protected. This level also allows for a granular analysis of health conditions, including rare diseases.

To achieve the above and other objects, the present invention is directed to an all-encompassing methodology for harvesting and utilizing healthcare data derived from various commercial EHR vendors in the visual and statistical assessment of population health characteristics. Health characteristics include, but are not limited to, patient demographics, vital signs, allergies, problem lists, medications, laboratory results, pathology results, radiology results, physician and nursing documentation and other essential health characteristics. Population health characteristics are then compared visually and statistically to multiple environmental, population, geographic, retail, and other factors.

The invention describes a methodology for mining, validating, cleaning, de-identifying, geocoding, and analyzing data derived from EHR systems. The primary objective of one or more aspects of this invention is to protect the privacy of the patient, while preserving the healthcare data granularity for analysis.

The present invention can be differentiated from anything else in the field by extracting granular and essential EHR-derived data, filtering and cleaning the data, de-identifying the personal health information, ensuring the data integrity, patient privacy, and performing statistical validation. Further, the methodology is differentiated by focusing on population-level health outcomes and geospatial mapping, by drawing on thousands of granular patient EHR demographic and essential health data.

The present invention improves upon previous methodologies by focusing on population level health outcomes through the use of millions of specific, de-identified health elements in each patient's EHR within a defined population. It clearly and thoroughly covers every step of how to integrate a GIS with EHR-derived data and use data mining tools to spatially analyze EHR data, including proper selection of appropriate EHR data fields, retrieving EHR data (using three ubiquitous reporting languages), cleaning, and de-identifying the data. Further, it expounds upon how to examine the cleaned EHR data against multiple geographic/environmental data layers in a GIS and how to complete statistical spatial analyses of the EHR data in a database using data mining tools.

The invention concerns the development of a data extraction and analysis methodology for combining EHR-derived data with geospatial technologies. Geospatial information is a common way of analyzing environmental impact on populations and has only recently been combined with EHR-derived data to yield important environmental correlations. The inventors have developed a methodology for deriving, validating, de-identifying, geocoding, and displaying EHR-derived data in a geospatial context while protecting the privacy of the human subjects. This invention can be used to display static results or actively geocode dynamic fields integrated in an EHR.

The invention provides a methodology of mining, validating, de-identifying, geocoding, analyzing, and displaying of EHR data consisting of: (1) Creating a dataset query in the data language set by the respective EHR creator, (2) Exporting that data to a multi-interface format (ex. CSV, TDV) (3) Validating data by assuring set parameters are met, (4) De-identifying data by removing all 17 protected health information (PHI) indicators, with the exception of Street Address, City, State, and Zip Code which must be preserved for geocoding, (5) Geocoding of the EHR data to an accuracy of +/−0.001 degrees of latitude and longitude, (6) Removing all remaining PHI from data file, and (7) Uploading data into the GIS for analysis.

In some embodiments, retrospective data is processed and placed onto a secure web host for quick access. The system includes a server storage pathway and a web interface in which data owners can view their geographic data as well as other partner's data as a benchmark tool. Data from both entities are secured and de-identified to protect the population being analyzed.

In some embodiments, data is input directly from an EHR and returned to the EHR in real time as a geographic display. This display could then be used to show co-variables of interest to the EHR user.

The invention can be implemented on any suitable hardware and software. The software can be supplied on any suitable persistent or non-persistent medium.

Definitions:

Electronic Health Record (EHR): an evolving concept defined as a systematic collection of electronic health information about individual patients or populations. It is a record in digital format that is capable of being shared across different health care settings. In some cases this sharing can occur by way of network-connected enterprise-wide information systems and other information networks or exchanges. EHRs may include a range of data, including demographics, medical history, medication and allergies, immunization status, laboratory test results, radiology images, vital signs, personal stats like age and weight, and billing information.

Geocoding: the process of finding associated geographic coordinates (often expressed as latitude and longitude) from other geographic data, such as street addresses, or ZIP codes.

GIS: A system designed to capture, store, manipulate, analyze, manage, and present all types of geographical data. In the simplest terms, GIS is the merging of cartography, statistical analysis, and database technology.

HIPAA: The Health Insurance Portability and Accountability Act of 1996 enacted by the United States Congress and signed by President Bill Clinton in 1996.Title I of HIPAA protects health insurance coverage for workers and their families when they change or lose their jobs. Title II of HIPAA, known as the Administrative Simplification provisions, requires the establishment of national standards for electronic health care transactions and national identifiers for providers, health insurance plans, and employers. The Administrative Simplification provisions also address the security and privacy of health data. The standards are meant to improve the efficiency and effectiveness of the nation's health care system by encouraging the widespread use of electronic data interchange in the U.S. health care system.

HTML: Hypertext Markup Language; a markup language used to produce web apps and interfaces.

ODBC: Open Database Connectivity; A standard connection API used to connect a database management system with the data server. ODBC can be used on any operating system and with many database management systems currently in production, including geospatial technologies.

SQL: Standard Query Language; a special-purpose programing language used to gather and compile data in a relational database management system. SQL contains many parts and variation to its programing language, but is operating system independent.

XML: Extensible Markup Language; A markup language, and its derivatives, used to produce web base interfaces that are both human-readable and machine-readable.

### BRIEF DESCRIPTION OF THE DRAWINGS

A preferred embodiment of the present invention will be set forth in detail with reference to the drawings, in which:

FIG. 1 is a block diagram of the overall methodology;

FIG. 2 is a point analysis map of all patients seen at the inventor's hospital and primary care clinics during Calendar year 2009;

FIG. 3 is an analytical map of the same points in FIG. 2, specifically looking at patients with obesity as a healthcare-specific condition;

FIG. 4 is a table illustrating how distance may be extrapolated from GIS for further statistical analysis;

FIG. 5 demonstrates a web interface for use in displaying the results of this method;

FIG. 6 shows a possible method for integration of these results into the EHR; and

FIG. 7 is a block diagram showing hardware on which the preferred embodiment can be implemented.

### DETAILED DESCRIPTION OF THE PREFERRED EMBODIMENT

A preferred embodiment of the present invention will be set forth in detail with reference to the drawings, in which like reference numerals refer to like elements or steps throughout.

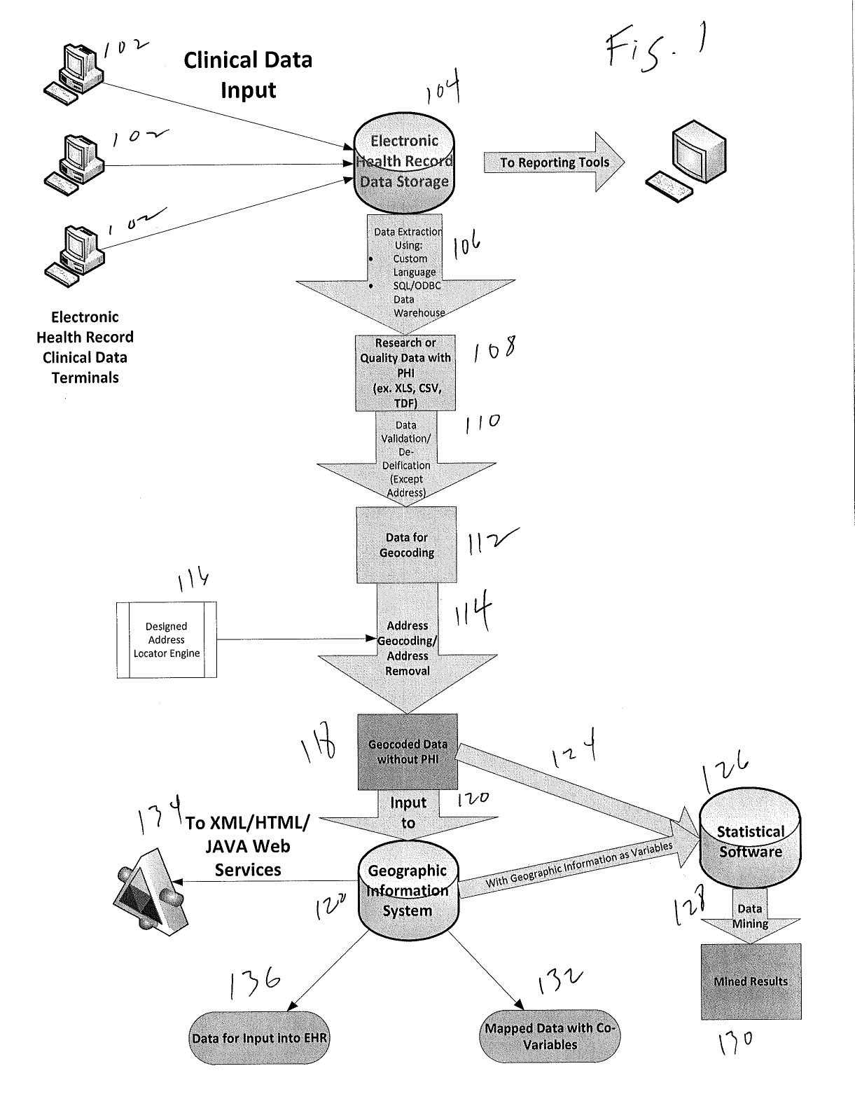

An overview of the invention is shown in the flow chart of FIG. 1.

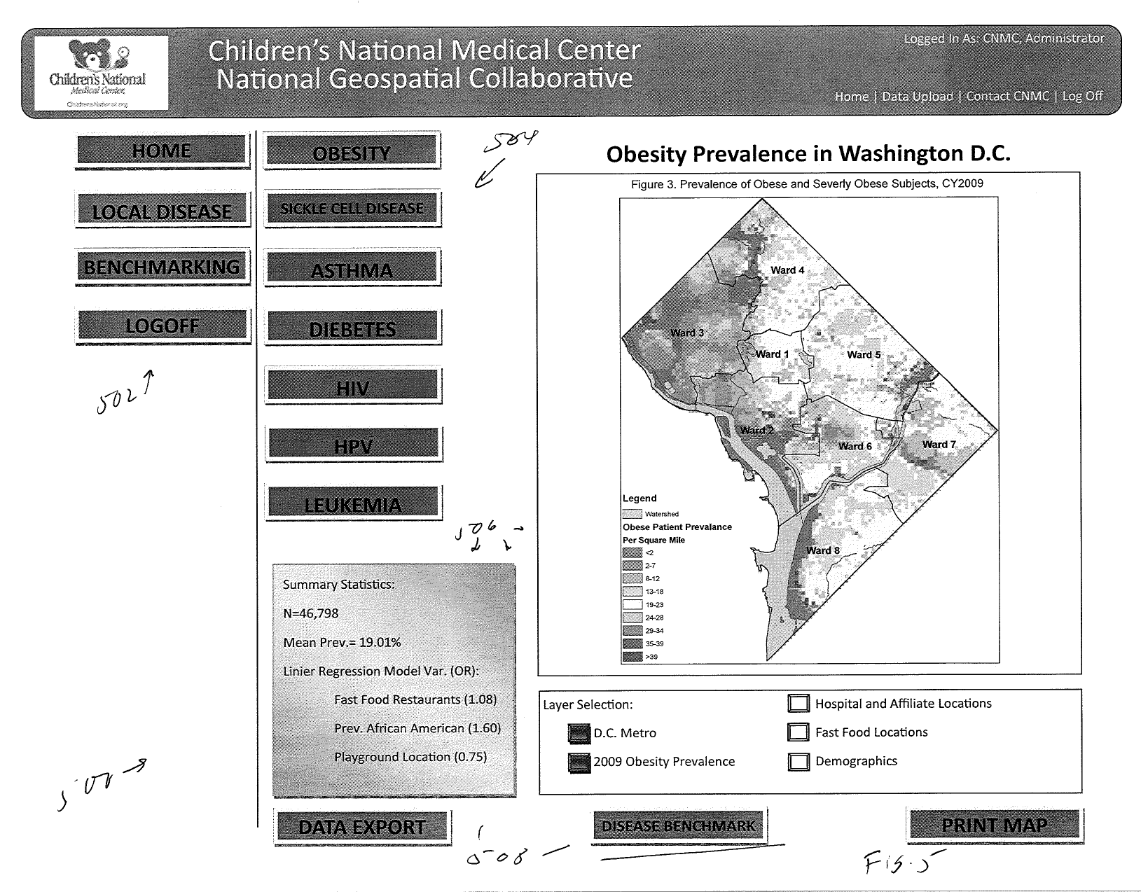

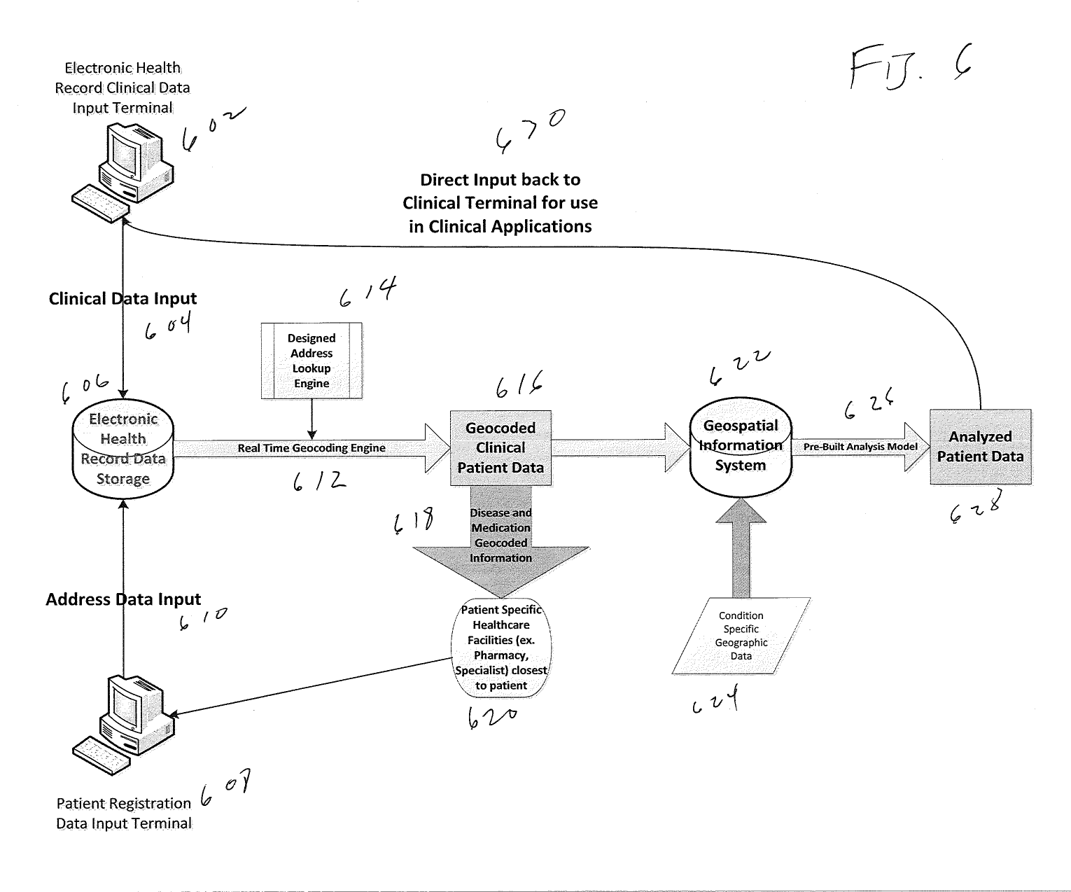

FIG. 1 illustrates the key aspects of the methodology. Clinical and personal data is first collected by clinical data terminals 102 and input into the EHR data structure 104. Data is then extracted in step 106 from respective EHR platforms using either open source or proprietary coding languages to provide research or quality data with PHI (protected health information) in step 108. The data fields extracted can be infinite; however, street address, city, state, and Zip code or pre-identified geo-coordinates (Latitude and Longitude or polar points) must be included in the data set. Data is then validated in step 110 for each EHR platform to assess the parameters of the data and to provide data for geocoding in step 112. Protected health information, not including address information, is removed from the data file in step 114. Subject's address, in conjunction with an address locator engine 116, is then used to assign a pair of latitude and longitude coordinates to each record using traditional geocoding methods to provide geocoded data 118. If the subject already has assigned accurate geo-coordinates, those are left unchanged. Assigned geo-coordinates, derived either from geocoding the address or an internal system assignment, are then rounded to the +/−0.001° level to protect subject privacy. (An area approximately 500 linier for both latitude and longitude). Addresses information is then removed and the data file is ready for analysis. Data can then either be uploaded in step 120 to a GIS interface 122 and analyzed for geographic variance, or it can be sent in step 124 to an ODBC/SQL based dataset 126 and mined in step 128 using traditional data mining techniques to produce mined results 130. From the GIS, the data can be output to maps in step 132 for research purposes, XML/HTML/JAVA web apps in step 134 as shown in FIG. 5 (to be described below), or data to be fed back into the EHR platform in step 136. It is the intent of the invention that this methodology could also be run with a single piece of data (representing one subject) for use in real time geocoding in the healthcare setting as shown in FIG. 6 (to be described below).

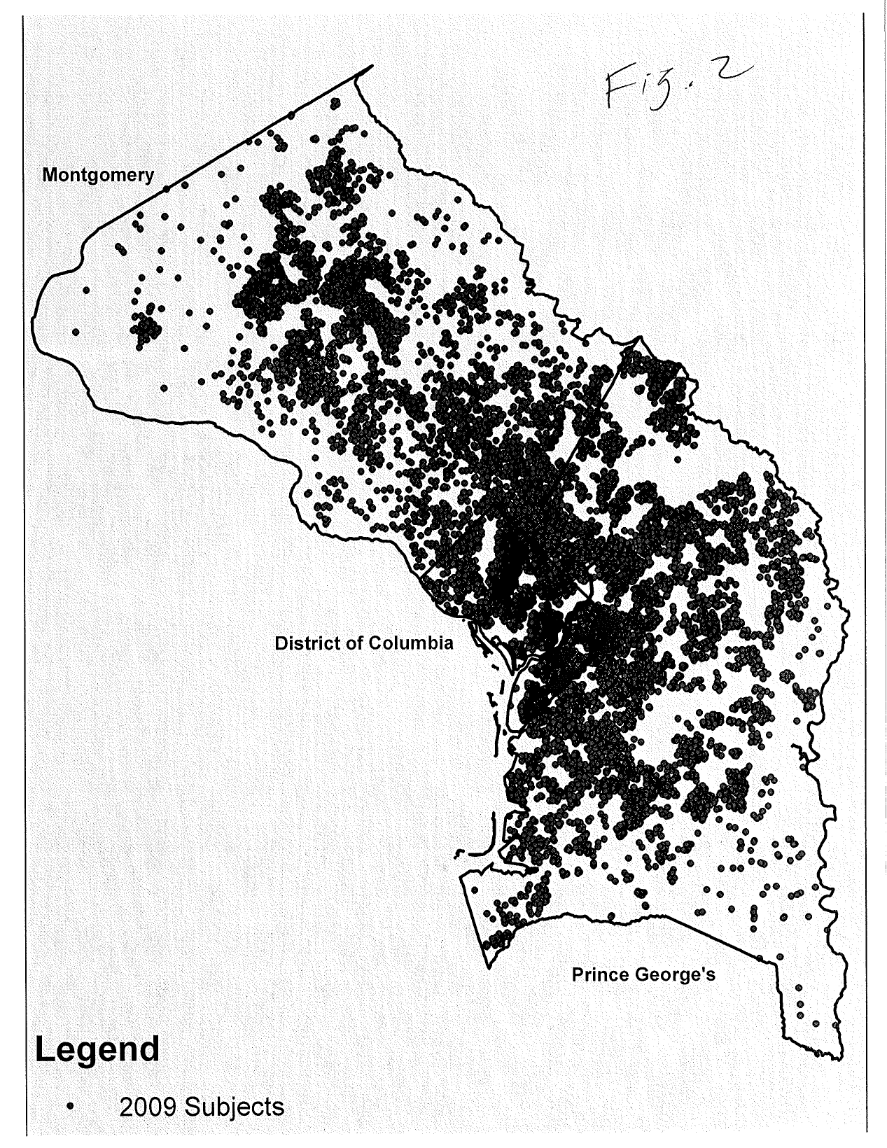

FIG. 2 shows the resulting geospatial embodiment after step 132 of FIG. 1. This particular embodiment of the invention relates directly to retrospective analytics more so than real time analytics. Subject data that is extracted in step 106 and cleaned and validated in steps 108 and 110 can be overlaid on a map to yield the map of FIG. 2. This allows for illustration of subject distribution and is the base for all other geospatial analytics. FIG. 2 represents the initial step in geospatial analysis and is thus part of the first preferred embodiment of this invention.

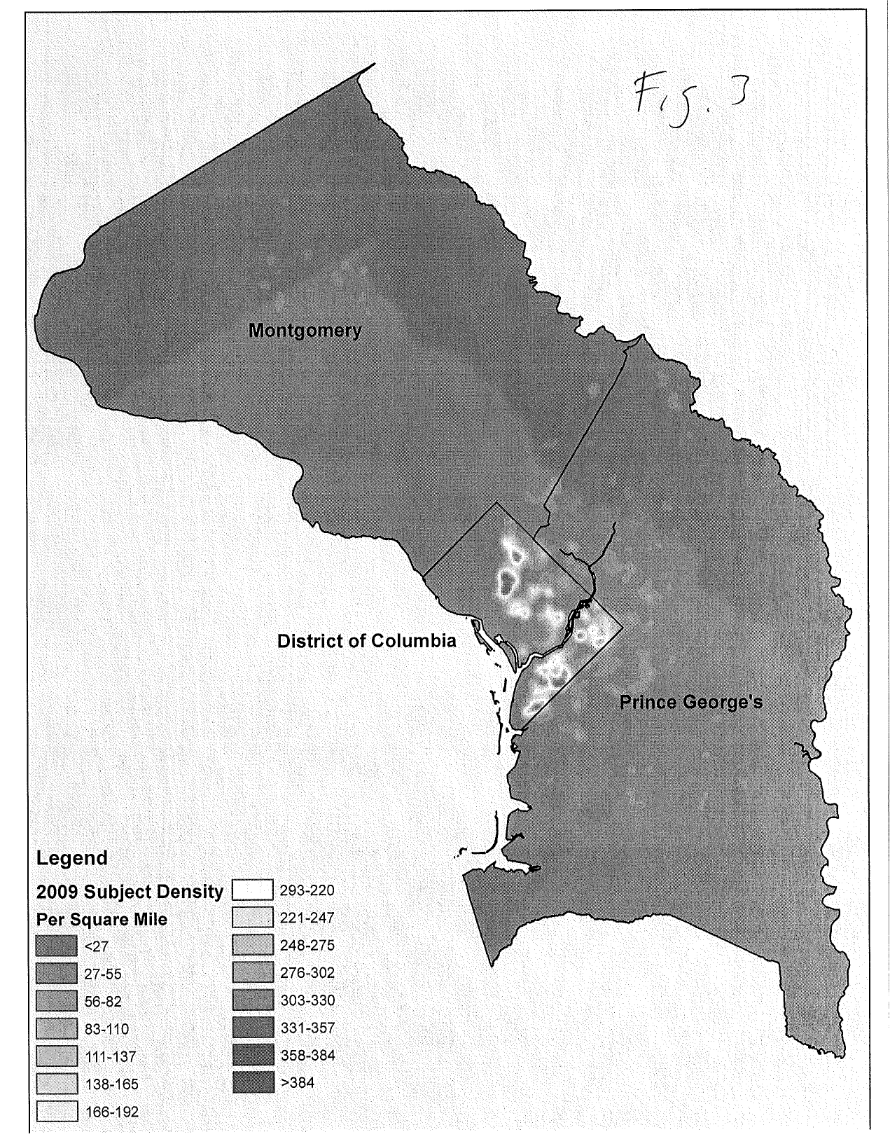

FIG. 3 is a continuation of the analytical process begun in FIG. 2. FIG. 3 shows a density analysis of the retrospective point data shown in FIG. 2. FIG. 3 is one of many analytical end points for the first embodiment. It represents a usable product that can be assessed to impact change over specific areas of healthcare (i.e. Disease impacts).

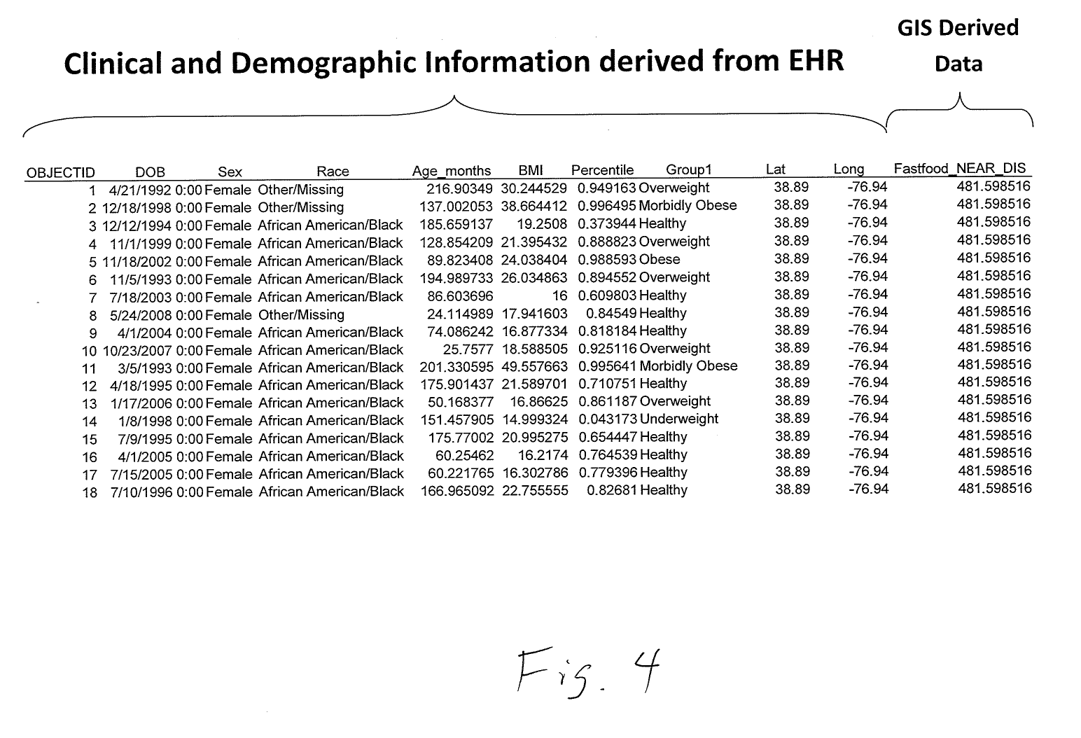

FIG. 4 illustrates the capability for geospatial variables to be exported from the GIS into a user friendly, tabular format. This format can be used in traditional statistical software packages to execute statistical tests that cannot normally be completed in the GIS environment. This allows for the invention to be used in a multi-facet environment, while doing multi-focal analysis, and presenting results in a variety of ways.

FIG. 5 represents a second embodiment of this invention, a web interface 500 that can be used to submit and display results from EHR data. Partner institutions would be able to submit data they had extracted from their EHR, in a manner consistent with FIG. 1. Analysis would then be performed, and specific outcome measures would be displayed for the partner organization. The partner organization could also see a benchmarking application, in which their data on a specific condition of interest is compared to other partner institutions.

The interface can be implemented on any client computer using a Web browser. On the left are “Home,” “Local Disease,” “Benchmarking,” and “Logoff” buttons, collectively designated 502. A set of buttons 504 allows a researcher to select a disease for which information is to be shown. The data display is shown as 506. Further options are selected through buttons 508. Of course, the layout is illustrative rather than limiting; also, the manner in which such a Web page is to be implemented is considered to be within ordinary skill in the art and will therefore not be described in detail here.

FIG. 6 displays an embodiment which modifies the methods presented in FIG. 1 to incorporate the use of a unique patient record in real time geocoding. This will allow for the integration of this methodology into real time geocoding of patient information from the EHR, analysis of that data, and display of that data back to the EHR clinical data terminal.

At an EHR clinical data input terminal 602, data are transmitted in step 604 to an EHR data storage 606. At a patient registration data input terminal 608, address data are transmitted in step 610 to the data storage 606. A real-time geocoding engine 612 and an address lookup engine 614 provide geocoded clinical patient data 616. Disease and medication geocoded information 618 can be provided to the facilities (e.g., a pharmacy or specialist) closest to the patient. A GIS 622, using the geocoded clinical patient data 616 and condition-specific geographic data 624, uses a pre-built analysis model 626 to provide analyzed patient data 628, which can be sent back to the clinical terminal 602 in step 630 for use in clinical applications.

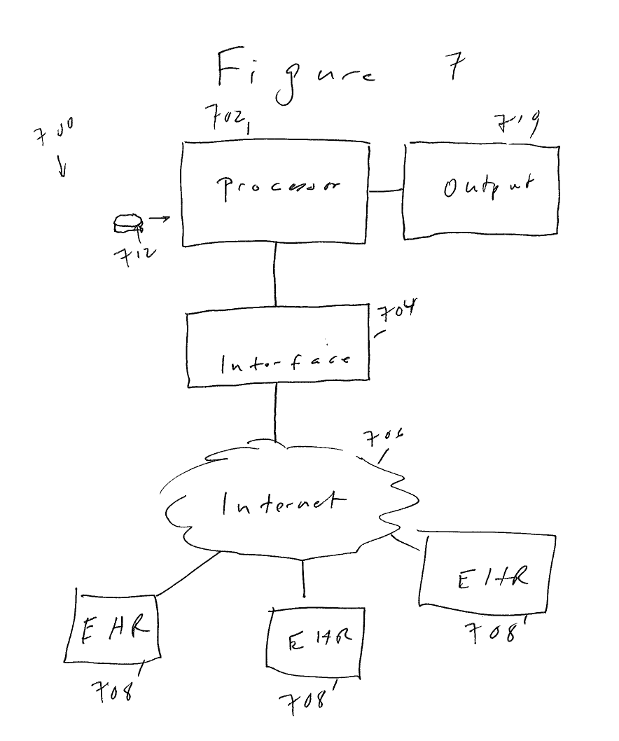

FIG. 7 is a schematic diagram showing a hardware system 700 on which the preferred or any other embodiment can be implemented. A processor 702, which can be any processor capable of carrying out the method disclosed herein, communicates through a communication interface (e.g., LAN/WAN adapter) 704 and a communication media (such as the Internet) 706 with one or more EHR's 708. The results of the method can be output through an output 710, which can include one or more of a display, a printer, a persistent storage, or a communication interface to an offsite recipient. The software used to implement the method can be supplied on any persistent or non-persistent medium 712.

While a preferred embodiment has been set forth in detail above, those skilled in the art who have reviewed the present disclosure will readily appreciate that other embodiments can be realized within the scope of the invention. For example, recitations of specific numerical values and of specific database technologies are illustrative rather than limiting. Therefore, the present invention should be construed as limited only by the appended claims.

We claim:

1. A method implemented in a computer processor for performing regional or national analysis of electronic health record (EHR) data, the method comprising:
(a) extracting the EHR data into the processor;
(b) filtering and cleaning the EHR data in the processor;
(c) geocoding the EHR data in the processor; and
(d) mapping the EHR data in the processor to a geographic information system.

2. The method of claim 1, wherein the EHR data comprise data from multiple EHR's.

3. The method of claim 2, wherein step (a) comprises:
(i) identifying data fields to query from each of the EHR's;
(ii) generating a data query in accordance with the data fields identified in step (a)(i); and
(iii) running the data query against each of the EHR's.

4. The method of claim 1, wherein step (b) comprises filtering out at least one of unnecessary data, incorrect data, and unusable data.

5. The method of claim 1, wherein step (c) comprises creating latitude and longitude coordinates for the filtered and cleaned data.

6. The method of claim 1, further comprising de-identifying the EHR data.

7. The method of claim 6, wherein the EHR data are de-identified by removing at least one of patient names, patient birth dates, and patient identifying numbers.

8. The method of claim 7, wherein the EHR data are further de-identified by reducing a granularity of the geocoding.

9. The method of claim 1, wherein step (d) comprises mapping the EHR data against co-variables.

10. The method of claim 9, wherein the co-variables comprise census data.

11. The method of claim 1, further comprising (e) data mining the de-identified data.

12. The method of claim 11, wherein step (e) comprises at least one of hierarchical, cluster, and neural network data relationships with two or more variables.

13. The method of claim 1, in which a result of step (d) is made available over a secure Web host.

14. The method of claim 1, in which a result of step (d) is returned to an EHR from which the EHR data are extracted.

15. A system for performing regional or national analysis of electronic health record (EHR) data, the system comprising:
a communication component for communicating with at least one EHR; and
a processor, in communication with the communication component, the processor being configured for:
(a) extracting the EHR data into the processor;
(b) filtering and cleaning the EHR data in the processor;
(c) geocoding the EHR data in the processor; and
(d) mapping the EHR data in the processor to a geographic information system.

16. The system of claim 15, wherein the communication component is in communication with multiple EHR's, and wherein the EHR data comprise data from the multiple EHR's.

17. The system of claim 16, wherein the processor is configured to perform step (a) by:
(i) identifying data fields to query from each of the EHR's;
(ii) generating a data query in accordance with the data fields identified in step (a)(i); and
(iii) running the data query against each of the EHR's.

18. The system of claim 15, wherein the processor is configured to perform step (b) by filtering out at least one of unnecessary data, incorrect data, and unusable data.

19. The system of claim 15, wherein the processor is configured to perform step (c) by creating latitude and longitude coordinates for the filtered and cleaned data.

20. The system of claim 15, wherein the processor is further configured to de-identify the EHR data.

21. The system of claim 20, wherein the processor is configured to de-identify the EHR data by removing at least one of patient names, patient birth dates, and patient identifying numbers.

22. The system of claim 21, wherein the processor is configured to de-identify the data further by reducing a granularity of the geocoding.

23. The system of claim 15, wherein the processor is configured to perform step (d) by mapping the EHR data against co-variables.

24. The system of claim 23, wherein the co-variables comprise census data.

25. The system of claim 15, wherein the processor is further configured to perform (e) data mining the de-identified data.

26. The system of claim 25, wherein the processor is configured to perform step (e) by at least one of hierarchical, cluster, and neural network data relationships with two or more variables.

27. The system of claim 15, wherein the processor is further configured to display a result of step (d) over a secure Web host.

28. The system of claim 15, wherein the processor is further configured to return a result of step (d) to an EHR from which the EHR data are extracted.
